(19) United States
(12) Patent Application Publication
(10) Pub. No.: US 2011/0221147 A1
(43) Pub. Date: Sep. 15, 2011

(54) TRIANGULAR LOOP HANDLE WITH THREE GRIPS

(75) Inventors: STEPHEN D. HATCHER, Camp Hill, PA (US); Eric Hyp, Harrisburg, PA (US); Daniel F. Marshall, Enola, PA (US)

(73) Assignee: AMES TRUE TEMPER, INC., CAMP HILL, PA (US)

(21) Appl. No.: 12/875,679

(22) Filed: Sep. 3, 2010

(51) Int. Cl. B62B 1/18; B62B 5/06

(52) U.S. Cl. 280/47.31; 16/421

(57) ABSTRACT

A handle for a wheelbarrow is provided. The handle has a body with a handle portion and a coupling device. The handle portion has three grips. The handle body forms a loop having arcuate transition portions between the grips. The grips are angled relative to the wheelbarrow frame assembly handle shafts so as to provide the user with a comfortable grip during both transport of the wheelbarrow as well as during a lifting motion of the handles.

### FIELD OF THE INVENTION

The present invention relates to handles for garden tools and, more specifically, to a handle shaped as a triangular loop and structured for use with a wheelbarrow.

### BACKGROUND OF THE INVENTION

As is well known, a wheelbarrow has a hopper or tray and a frame assembly. The frame assembly includes at least one wheel, typically disposed at the front of the tray, and a pair of handles extending behind the tray. While some wheelbarrows are structured for transport only, most wheelbarrows include a wheel guard that extends around the front side of the wheel. When the handles are lifted, the wheel guard engages the ground, thereby allowing the user to more easily tip the tray.

Traditionally, the handles of a wheel barrow were simple shafts which may have included a shaped grip. When the wheelbarrow was at rest, the handles extended generally horizontally, or more typically with a slight upward angle. In this configuration, the handles, and more specifically the grips, could be supported by a user's fingers. That is, the user's fingers would engage the lower side of the grips. When the user lifted their hands, the wheelbarrow would rotate slightly about the axis of the wheel, thereby lifting a pair of supports off the ground and allowing the user to easily move the wheelbarrow. Generally, this is an ergonomic configuration. That is, the user's wrists were generally straight.

This type of handle, however, was not as ergonomic as the user lifted the handles when dumping the cargo out of the tray. That is, as the user lifted the handles, the user's wrist's bent until the user could no longer grip the handles from above. At that point, if the tray needed to be tilted further, the user would have to switch from an overhand grip on the handle to an underhanded grip. This motion was, typically, performed quickly and may be described as “clean-and-jerk,” as in weightlifting. Thus, the handles and grips of a traditional wheelbarrow handle is not especially ergonomic when used to tip the tray. Moreover, this type of handle required the user to, essentially, release the handle during the clean-and-jerk transition between grips.

Several attempts have been made to overcome this uncomfortable type of wheelbarrow grip. Generally, and as seen in U.S. Pat. Nos. 5,601,298; 5,810,375; and 6,336,254 the solution was to provide a downwardly extending arcuate grip extending from the distal end of the handle. This type of handle allowed the user to “walk” their grip about the handle. That is, as the handle traveled over the arc defined by the lifting motion, the user could make small adjustments in the position of their hands on the arcuate portion of the handle. The size/shape of the arcuate portion was structured to provide the user with a handle that allowed their wrist to be generally straight as the wheelbarrow handle traveled through the lifting arc. While such handles are an improvement over the traditional straight handles, such handles are still uncomfortable as a human hand is not structured to comfortably grip a member with a small and/or continuous radius of curvature. This is a disadvantage given the stress placed on a user's fingers when tilting the wheelbarrow.

### SUMMARY OF THE INVENTION

The disclosed and claimed concept relates to a handle that has three grips. Such a handle is adapted for use with a wheelbarrow, but may be used on other tools or devices as well. The handle body forms a triangular loop having generally arcuate transition portions between the grips. The grips are angled relative to the wheelbarrow frame assembly handle shafts so as to provide the user with a comfortable grip during both transport of the wheelbarrow as well as during a lifting motion of the handles. That is, the handle includes a first grip that, essentially, corresponds to a traditional grip in that the grip is substantially parallel, and more preferably aligned, with the longitudinal axis of the handle shafts. The first grip is used during normal transport of the wheelbarrow with the user's fingers engaging the lower side of the grip. The second grip, which is disposed below the first grip, is angled about 60 degrees relative to the first grip. In this configuration, the second grip is positioned so that the user may comfortably grasp the handle while the wheelbarrow is being tilted forward. The third handle is angled about 25 degrees relative to the first grip. In this configuration, the third grip is positioned so that the user may comfortably grasp the handle while the wheelbarrow is in a substantially vertical orientation.

### BRIEF DESCRIPTION OF THE DRAWINGS

A full understanding of the invention can be gained from the following description of the preferred embodiments when read in conjunction with the accompanying drawings in which:

FIG. 1 is an isometric view of a wheelbarrow.

FIG. 2 is a side view of the handle.

FIG. 3 is a side view of an alternate handle.

FIG. 4 is a side view of the wheelbarrow in three positions as the wheelbarrow is tilted forward.

### DESCRIPTION OF THE PREFERRED EMBODIMENTS

As used herein, directional terms, such as, but not limited to, “forward,” “back,” “right,” “left,” “upper,” “lower,” and “lateral” correspond to the orientation of the wheelbarrow from the perspective of a user standing at the handle portion looking toward the tray—that is, the normal position a user would occupy to move the wheelbarrow. Such directional terms are not limiting upon the claims.

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein a “handle” is an element that is generally structured to be grasped by a user and not an element that is merely capable of being grasped. For example, a wheelbarrow frame assembly may have a plurality of elongated members that may be grasped, but only the handles are structured, i.e. positioned and sized, to be grasped by the user.

As used herein, a “grip” is the portion of a handle structured to be gripped by a user. A “grip” includes a portion of a handle having a sufficient, substantially straight length of handle to accommodate the width of four fingers, and may also include a textured surface on the handle and/or a padded portion of the handle. A “grip” must, however, be distinguishable from other portions of the handle. For example, a smooth, straight broomstick is a handle without an identifiable grip because no portion of the handle is different than any other portion. Similarly, a smooth, arcuate wheelbarrow handle, such as the one disclosed in U.S. Pat. No. 6,336,254, is only a handle that does not include a “grip” as no portion of the arcuate handle is different than any other portion.

As used herein, the “radius of curvature” of a specific component means a general radius of curvature for the component. That is, the component may not be exactly arcuate, i.e. having a single center, but rather formed from one or more curves, lines and/or splines that approximate an arc. It is noted that a straight handle does not have a “radius of curvature” under this definition. Similarly, the phrase “extending over an arc” includes lines and/or splines that approximate an arc without being exactly arcuate.

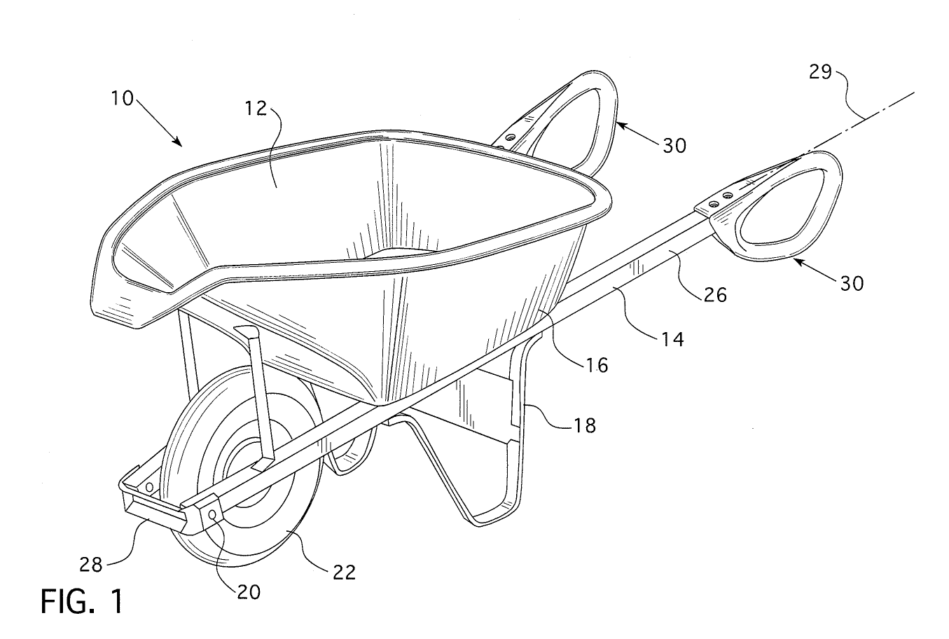

A wheelbarrow 10 is shown in FIG. 1. The wheelbarrow 10 includes a tray 12 and a frame assembly 14. The tray 12, which may be flat, is structured to support a load and, as shown, typically includes a sidewall 16 that extends upwardly from a base (not shown). The frame assembly 14 includes a plurality of members 18 that form a yoke 20 for a wheel 22, supports 24, and two handle shafts 26. The yoke 20 and the wheel 22 are disposed on the front side of the tray 12. A wheel guard 28 extends between the tips of the yoke 20. The wheel guard 28 is structured to engage the ground when the wheelbarrow 10 is tilted forward. The engagement of the wheel guard 28 with the ground generally prevents the wheelbarrow 10 from moving forward as it is being tilted. The supports 24 are structured to support the tray 12 when the wheelbarrow 10 is at rest. The handle shafts 26 extend, preferably, at an upward angle from the back side of the tray 12. The handle shafts 26 are typically disposed on opposing lateral sides of the tray 12. The handle shafts 26 are elongated and each have a longitudinal axis 29. In this configuration, a user may stand between the handle shafts 26 when using the wheelbarrow 10.

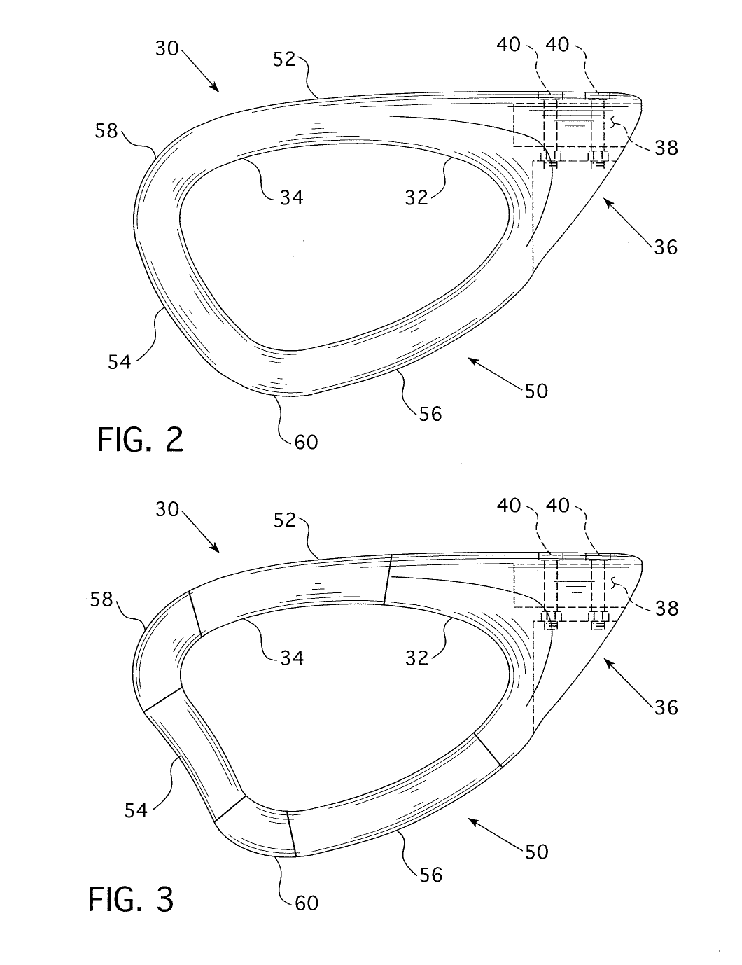

The wheelbarrow 10 further includes a handle 30, shown in FIG. 2, disposed on each handle shaft 26. As the handles 30 are substantially similar, preferably being either identical or mirror images, only one handle 30 is described below. It is understood that a handle 30 is disposed on each handle shaft 26. The handle 30 includes a body 32 having a handle portion 34 and a coupling device 36. The coupling device 36 is structured to fix the body 32 to the distal end of one handle shaft 26. As shown, the coupling device 36 is preferably a socket 38 sized to fit about the distal end of a handle shaft 26. Additionally, fasteners 40, such as, but not limited to, a bolt may extend through both the body 32 and the handle shaft 26.

The body handle portion 34 defines an asymmetrical loop 50. The loop 50 has three elongated grip portions, a first grip 52, a second grip 54 and a third grip 56. The loop 50 further has a first transition portion 58 disposed between the first grip 52 and the second grip 54, as well as a second transition portion 60 disposed between the second grip 54 and the third grip 56. The elongated grips 52, 54, 56 provide a surface having sufficient length so as to allow a user to comfortably grasp the grip 52, 54, 56. That is, the grips 52, 54, 56 do not have a radius of curvature smaller than 120 mm. Preferably, the first grip 52 has a length between 120 mm and 210 mm, and more preferably 150 mm. The second grip 54 has a length between 100 mm and 200 mm and more preferably 150 mm. The third grip 56 has a length between 100 mm and 200 mm, and more preferably 140 mm. Further, the first grip 52 has a radius of curvature between about 300 mm and 400 mm, and more preferably about 350 mm. The second grip 54 has a radius of curvature between about 120 mm and 250 mm, and more preferably about 217. The third grip 56 has a radius of curvature between about 300 mm and 400 mm, and more preferably about 280. These measurements are for one embodiment of the body handle portion 34, e.g. for a wheelbarrow handle 30.

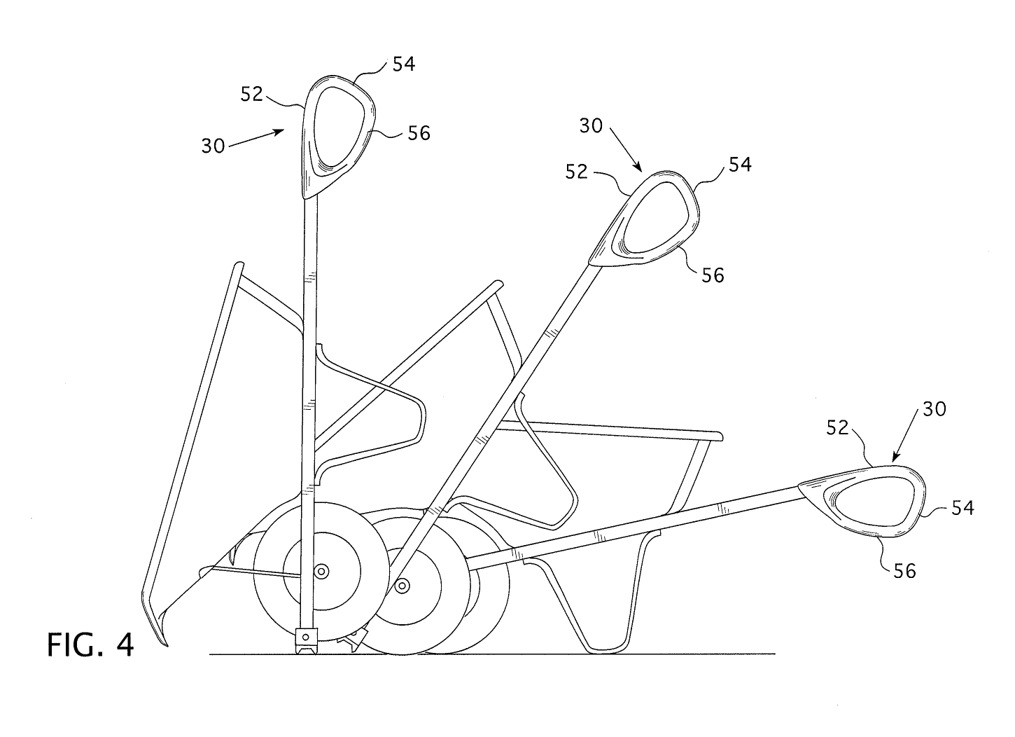

The curvature of the grips 52, 54, 56 is, preferably, convex relative to the perimeter of the loop 50. That is, the curvature of the grips 52, 54, 56 compliments the curvature of the loop 50. In an alternate embodiment, as shown in FIG. 3, in which like reference numbers are used for corresponding components, the curvature of the second grip 54 is concave relative to the perimeter of the loop 50. That is, in this embodiment, the second grip 54 curves toward the interior of the loop 50. The preferred length and radius of curvature for the second grip is the same regardless of whether the second grip 54 is convex or concave.

Another feature of the grips 52, 54, 56 is their angle relative to the handle shaft 26. That is, as described below, the grips 52, 54, 56 are configured to reduce the stress on a user as the user tilts the wheelbarrow 10. As such, the grips 52, 54, 56 are angled so as to allow a comfortable hand/wrist position by the user as the handle shafts 26 move through an arc. The “angles” of the grips 52, 54, 56 are described in reference to the longitudinal axis 29 of the handle shaft 26. The first grip 52 is structured to be used in a manner similar to a traditional wheelbarrow handle. As such, the first grip 52 is structured to extend substantially parallel to, and more preferably aligned with, the handle shaft longitudinal axis 29. The handle body 32 then curves downwardly to the second grip 54. Thus, the second grip 54 is structured to extend at an angle of between about 45 degrees and 75 degrees, and more preferably about 61 degrees, relative to the handle shaft longitudinal axis 29. The handle body 32 then curves forwardly to the third grip 56. Thus, the third grip is structured to extend at an angle of between about 45 degrees and 15 degrees, and more preferably about 25 degrees, relative to the handle shaft longitudinal axis 29.

The first and second transition portions 58, 60 (as well as an unnumbered third transition portion between the third grip 56 and the first grip 52) complete the loop 50. The first transition portion 58 has a radius of curvature between about 40 mm and 200 mm, and is more preferably about 45 mm. The first transition portion 58 extends over an arc of between about 80 degrees and 100 degrees, and more preferably about 90 degrees. The second transition portion 60 has a radius of curvature between about 50 mm and 300 mm, and is more preferably about 57 mm. The second transition portion 60 extends over an arc of between about 45 degrees and 90 degrees, and more preferably about 54 degrees.

As shown in FIG. 3, in operation, a user typically grasps the first grip 52 when moving the wheelbarrow 10 from one location to another. The weight of the wheelbarrow 10 is on the user's fingers in this configuration. When the user desires to tilt the wheelbarrow 10 so as to empty the tray 12, the user lifts on the handles 30. This lifting motion causes the wheelbarrow 10 to pivot about the axle of the wheel 22 until the wheel guard 28 engages the ground. At this point a continued lifting motion on the handles 30 causes the wheelbarrow 10 to pivot about the point where the wheel guard 28 engages the ground. Thus, during the lifting motion, the handles 30 move, generally, through an arc. Depending upon the user's height, length of the handles 30, and how far the tray 12 needs to be tilted, and as noted above, the user will likely switch from an overhand grip to an underhand grip.

While the point of changeover varies from person to person, most users will change from the first grip 52 to the second grip 54 when the handle shafts 26 are at an angle of about 25 degrees relative to a horizontal surface, e.g. the ground. At this point in time, the second grip is at an angle of about 95 degrees to a horizontal surface. In this orientation, the user flips from a “finger” grip to a palm grip. That is, the weight of the wheelbarrow 10 is on the user's palms with the fingers encircling the second grip 54 for control. The user may then continue to tilt the wheelbarrow forwardly. As the handle shafts 26 approach a vertical orientation, at about 90 degrees to a horizontal surface, the user will slide their hands to the third grip 56. At the point of the second changeover, the third grip 56 is typically at an angle of about 85 degrees to a horizontal surface. It is noted that just before the first changeover in the user's grasp, the first grip 52 is at an angle of about 25 degrees to a horizontal surface. Just before the second changeover in the user's grasp, the second grip 54 is at an angle of about 29 degrees to a horizontal surface.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A handle for a wheelbarrow handle shaft, said wheelbarrow having a tray and a frame assembly, said frame assembly having two elongated handle shafts, each said handle shaft extending rearwardly relative to said tray, each handle shaft having a longitudinal axis, said handle comprising:
a body having a handle portion and a coupling device;
said coupling device structured to fix said body to one said handle shaft;
said body handle portion defining a loop, said loop having three elongated grips, a first grip, a second grip and a third grip, said loop further having a first transition portion disposed between said first grip and said second grip, and, a second transition portion disposed between said second grip and said third grip.

2. The handle of claim 1 wherein:
said first grip is structured to extend substantially parallel to a handle shaft longitudinal axis;
said second grip is structured to extend at an angle of between about 45 degrees and 75 degrees relative to said handle shaft longitudinal axis; and
said third grip is structured to extend at an angle of between about 45 degrees and 15 degrees relative to said handle shaft longitudinal axis.

3. The handle of claim 2 wherein:
said second grip is structured to extend at an angle of about 61 degrees relative to a handle shaft longitudinal axis; and
said third grip is structured to extend at an angle of about 25 degrees relative to a handle shaft longitudinal axis.

4. The handle of claim 2 wherein:
the radius of curvature of said first transition portion is between about 300 mm and 400 mm; and
the radius of curvature second transition portion is between about 120 mm and 250 mm.

5. The handle of claim 4 wherein:
the radius of curvature of said first transition portion is about 350 mm; and
the radius of curvature second transition portion is about 217 mm.

6. The handle of claim 2 wherein said first grip is structured to be substantially aligned with a handle shaft longitudinal axis.

7. The handle of claim 2 wherein:
said second grip has a length between about 100 mm and 210 mm; and
said second grip is concave, having a radius of curvature between about 120 mm and 250 mm.

8. The handle of claim 7 wherein:
said second grip has a length of about 150 mm; and
said second grip radius of curvature being about 217 mm.

9. The handle of claim 2 wherein:
said first grip has a length between about 120 mm and 210 mm;
said first grip is convex, having a radius of curvature between about 300 mm and 400 mm;
said second grip has a length between about 100 mm and 210 mm;
said second grip is convex, having a radius of curvature between about 120 mm and 250 mm;
said third grip has a length between about 100 mm and 200 mm; and
said third grip is convex, having a radius of curvature between about 400 mm and 300 mm.

10. The handle of claim 9 wherein:
said first grip has a length of about 175 mm;
said first grip radius of curvature being about 350 mm;
said second grip has a length of about 150 mm;
said second grip radius of curvature being about 217 mm;
said third grip has a length of about 140 mm; and
said third grip radius of curvature being about 280 mm.

11. A wheelbarrow comprising:
a tray and a frame assembly;
said frame assembly having two elongated handle shafts, each said handle shaft extending rearwardly relative to said tray, each handle shaft having a longitudinal axis;
said frame assembly further including one handle fixed to each handle shaft, each handle including a body having a handle portion and a coupling device;
said coupling device structured to fix said body to one said handle shaft;
said body handle portion defining a loop, said loop having three elongated grips, a first grip, a second grip and a third grip, said loop further having a first transition portion disposed between said first grip and said second grip, and, a second transition portion disposed between said second grip and said third grip.

12. The wheelbarrow of claim 11 wherein:
said first grip is structured to extend substantially parallel to a handle shaft longitudinal axis;
said second grip is structured to extend at an angle of between about 45 degrees and 75 degrees relative to said handle shaft longitudinal axis; and
said third grip is structured to extend at an angle of between about 45 degrees and 15 degrees relative to said handle shaft longitudinal axis.

13. The wheelbarrow of claim 12 wherein:
said second grip is structured to extend at an angle of about 61 degrees relative to a handle shaft longitudinal axis; and
said third grip is structured to extend at an angle of about 25 degrees relative to a handle shaft longitudinal axis.

14. The wheelbarrow of claim 12 wherein:
the radius of curvature of said first transition portion is between about 300 mm and 400 mm; and
the radius of curvature second transition portion is between about 120 mm and 250 mm.

15. The wheelbarrow of claim 14 wherein:
the radius of curvature of said first transition portion is about 350 mm; and
the radius of curvature second transition portion is about 217 mm.

16. The wheelbarrow of claim 12 wherein said first grip is structured to be substantially aligned with a handle shaft longitudinal axis.

17. The wheelbarrow of claim 12 wherein:
said second grip has a length between about 100 mm and 210 mm; and
said second grip is concave, having a radius of curvature between about 120 mm and 250 mm.

18. The wheelbarrow of claim 17 wherein:
said second grip has a length of about 150 mm; and
said second grip radius of curvature being about 217 mm.

19. The wheelbarrow of claim 12 wherein:
said first grip has a length between about 120 mm and 210 mm;
said first grip is convex, having a radius of curvature between about 300 mm and 400 mm;
said second grip has a length between about 100 mm and 210 mm;
said second grip is convex, having a radius of curvature between about 120 mm and 250 mm;
said third grip has a length between about 100 mm and 200 mm; and
said third grip is convex, having a radius of curvature between about 400 mm and 300 mm.

20. The wheelbarrow of claim 19 wherein:
said first grip has a length of about 175 mm;
said first grip radius of curvature being about 350 mm;
said second grip has a length of about 150 mm;
said second grip radius of curvature being about 217 mm;
said third grip has a length of about 140 mm; and
said third grip radius of curvature being about 280 mm.
